(19) United States
(12) Patent Application Publication
(10) Pub. No.: US 2012/0258682 A1
(43) Pub. Date: Oct. 11, 2012

(54) METHOD, TERMINAL, AND SYSTEM FOR AUTOMATICALLY TRANSFERRING INFORMATION ABOUT FALL OR OVERTURN ACCIDENT USING SMART PHONE

(75) Inventors: Duk-Sung JANG, Daegu (KR); Seung-Chan CHOI, Daegu (KR)

(73) Assignee: Industry Academic Cooperation Foundation Keimyung University, Daegu (KR)

(21) Appl. No.: 13/440,359

(22) Filed: Apr. 5, 2012

(30) Foreign Application Priority Data
Apr. 6, 2011 (KR) 10-2011-0031722

(51) Int. Cl. H04W 4/22; H04W 4/12

(52) U.S. Cl. 455/404.2; 455/404.1

(57) ABSTRACT

A method, a terminal, and a system for automatically transferring information about a fall or overturn accident using a smart phone are provided. The method includes, by an elder customer terminal assigned to an elder customer, detecting a fall or overturn accident via a 3-axis acceleration sensor, and sending a fall or overturn detection message, including its own ID information and a fall or overturn state, to a controller based on the detection, by the controller, receiving the fall or overturn detection message, generating fall or overturn detection information based on the received fall or overturn detection message, and registering the fall or overturn detection information with a database, and, by the controller, configuring a message based on the fall or overturn detection information, and notifying the smart phone of the message based on the fall or overturn detection information.

### PRIORITY

This application claims the benefit under 35 U.S.C. §119(a) of a Korean patent application filed on Apr. 6, 2011 in the Korean Intellectual Property Office and assigned Serial No. 10-2011-0031722, the entire disclosure of which is hereby incorporated by reference.

### BACKGROUND OF THE INVENTION

1. Field of the Invention

The present invention relates to a monitoring system for the old and the frail. More particularly, the present invention relates to a method, a terminal, and a system for automatically transferring information about a fall or overturn accident using a smart phone, which are capable of informing a manager of a fall or overturn accident via a smart phone in real time when an old or frail person has the fall or overturn accident.

2. Description of the Related Art

In a society in which the aged are sharply increasing in number, there is a need for the development of healthcare services that help the aged or handicapped lead safe everyday lives.

For example, according to research on the actual conditions of fall accidents of the old conducted on 357 people aged 65 and above in the Seoul area by the Korean Association for Safe Communities on Sep. 27 to 28, 2007, it was found that 8 out of 10 people have experienced fall accidents.

A slight injury may be fatal to the aged, unlike that to the young, and the aged may have a high fall or overturn accident rate because they are frail, thus losing or not keeping the balance.

There was a need for the development of technology that can rapidly deal with the occurrence of the fall or overturn accidents of the aged.

In general, in welfare centers for senior citizens, such as a silver town where a plurality of old persons lives, it is difficult for a limited number of managers to carefully manage each of a plurality of elder customers.

Furthermore, distributing terminals, such as expensive and multi-functional smart phones, to a plurality of elder customers in order to manage them is very expensive.

Accordingly, there is an urgent need to develop technology which can guarantee the safety of a plurality of elder customers by monitoring the fall or overturn accidents of the plurality of elder customers who live in welfare centers and which can significantly reduce the burden of costs attributable to the distribution of terminals by simplifying the configuration of the terminal.

### SUMMARY OF THE INVENTION

Aspects of the present invention are to address at least the above-mentioned problems and/or disadvantages and to provide at least the advantages described below. Accordingly, an aspect of the present invention is to provide a method and system for automatically transferring information about a fall or overturn accident using a smart phone, which are capable of guaranteeing the safety of a plurality of elder customers by monitoring the fall or overturn accidents of the plurality of elder customers and of significantly reducing the burden of costs attributable to the distribution of terminals and communication by simplifying the configuration of the terminal and using 400 MHz band wireless communication.

In accordance with an aspect of the present invention, a method of automatically transferring information about a fall or overturn accident using a smart phone is provided. The method includes, by an elder customer terminal assigned to an elder customer, detecting a fall or overturn accident via a 3-axis acceleration sensor, and sending a fall or overturn detection message, including its own ID information and a fall or overturn state, to a controller based on the detection, by the controller, receiving the fall or overturn detection message, generating fall or overturn detection information based on the received fall or overturn detection message, and registering the fall or overturn detection information with a database, and, by the controller, configuring a message based on the fall or overturn detection information, and notifying the smart phone of the message based on the fall or overturn detection information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 shows the configuration of a system for automatically transferring information about a fall or overturn accident using a smart phone according to an exemplary embodiment of the present invention;

FIG. 2 shows the configuration of a terminal for automatically transferring information about a fall or overturn accident according to an exemplary embodiment of the present invention;

FIG. 3 is a flowchart illustrating the automatic transfer of information about a fall or overturn accident according to an exemplary embodiment of the present invention;

FIG. 4A shows the structure of a fall or overturn detection message according to an exemplary embodiment of the present invention;

FIG. 4B is a diagram showing an example in which the message of a fall or overturn detection database is stored according to an exemplary embodiment of the present invention; and

FIG. 5 is a diagram illustrating a notification guidance screen based on the detection of a fall or overturn accident according to an exemplary embodiment of the present invention.

Throughout the drawings, it should be noted that like reference numbers are used to depict the same or similar elements, features, and structures.

### DESCRIPTION OF THE PREFERRED EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present invention can guarantee the safety of a plurality of elder customers by monitoring the fall or overturn accidents of the plurality of elder customers, and can significantly reduce the burden of costs attributable to the distribution of terminals and communication by simplifying the configuration of the terminals and using 400 MHz band wireless communication.

A method and system for automatically transferring information about a fall or overturn accident using a smart phone according to the present invention will be described in detail below with reference to the drawings.

<System for Automatically Transferring Information about a Fall or Overturn Accident Using a Smart Phone>

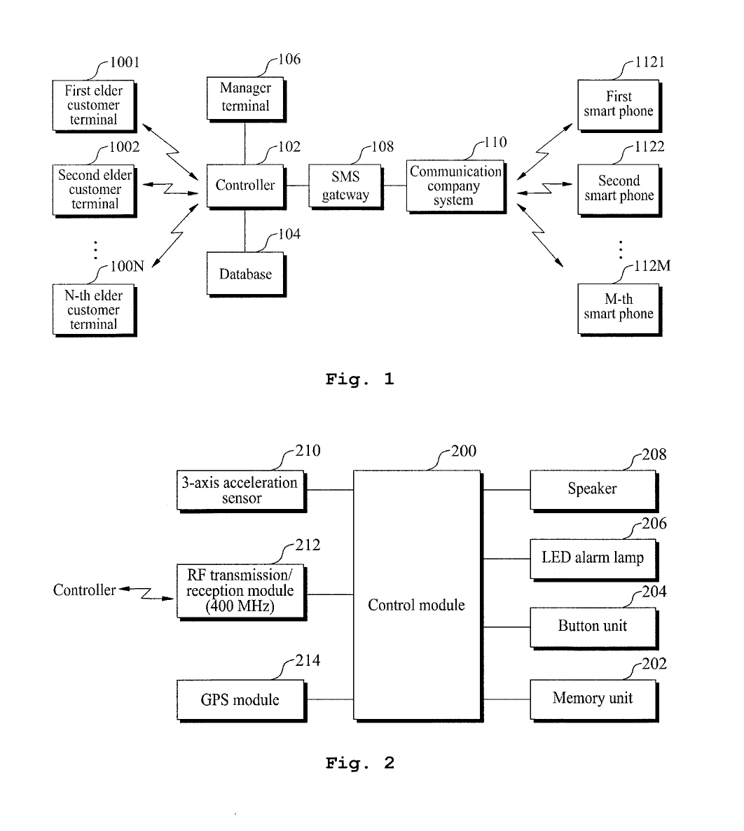

First, the configuration of the system for automatically transferring information about a fall or overturn accident using a smart phone according to an exemplary embodiment of the present invention will now be described in detail with reference to FIG. 1.

The system for automatically transferring information about a fall or overturn accident using a smart phone includes first to N-th elder customer terminals 1001 to 100N, a controller 102, a database 104, a manager terminal 106, a Short Message Service (SMS) gateway 108, a communication company system 110, and first to M-th smart phones 1121 to 112M.

The first to N-th elder customer terminals 1001 to 100M are distributed to elder customers. The first to N-th elder customer terminals 1001 to 100M each detect a fall or overturn accident occurring to the elder customer (i.e., a user), generate a fall or overturn detection message based on the detected fall or overturn accident, provide the fall or overturn detection message to the controller 102, and issue an alarm or drive an alarm lamp in compliance with an alarm output and alarm lamp drive command from the controller 102, thereby indicating the user's position. In particular, the first to N-th elder customer terminals 1001 to 100M and the controller 102 perform wireless communication using a frequency of 400 MHz. Accordingly, the terminal does not need to be equipped with an expensive communication module, such as a Code Division Multiple Access (CDMA) module, for wireless communication with the controller 102.

The controller 102 receives fall or overturn detection messages from the first to N-th elder customer terminals 1001 to 100 M, and processes the fall or overturn detection messages in order of the reception of the messages. In particular, the controller 102 checks whether each fall or overturn detection message is normal. If the fall or overturn detection message is normal, the controller 102 registers fall or overturn detection information with the database 104 based on the fall or overturn detection message, generates an SMS message corresponding to the fall or overturn detection message, and sends the SMS message to the smart phone of a guardian or manager, preset in association with a terminal ID included in the fall or overturn detection message, via the SMS gateway 108 and the communication company system 110. Here, although only the SMS message has been illustrated as being sent in the above example, a Multimedia Messaging Service (MMS) message may be sent or the reception of the fall or overturn detection message may be reported to the smart phone of a guardian or a manager using push notification technology.

Furthermore, if the fall or overturn detection message is not normal, the controller 102 provides an alarm lamp drive command to an elder customer terminal corresponding to a terminal ID included in the fall or overturn detection message. When the user presses a preset confirm key in response to the alarm lamp drive command and the elder customer terminal provides the controller 102 with a message corresponding to the pressed confirm key, the controller 102 disregards the fall or overturn detection message. If the message corresponding to the pressed confirm key is not provided, however, the controller 102 provides an alarm output and alarm lamp drive command and, at the same time, notifies the smart phone of a guardian or a manager, preset in association with the terminal ID of the elder customer terminal, to check the state of a relevant elder customer. As described above, according to the present invention, if an elder customer does not press a preset confirm key, the smart phone of a guardian or a manager is notified to check the state of the elder customer so as to allow for the case in which a fall or overturn detection message may be abnormally received due to a poor communication state, thereby guaranteeing the safety of the elder customer.

The database 104 stores fall or overturn detection information based on each fall or overturn detection message under the control of the controller 102. Furthermore, the database 104 stores the smart phone ID information of a guardian or a manager that is preset in association with each elder customer terminal ID. Furthermore, the database 104 stores elder customer information corresponding to each elder customer terminal ID. The elder customer information may include a name, a sex, and an age.

Furthermore, the manager terminal 106 accesses the database 104 through the controller 102, and performs tasks, such as the output of a history of fall or overturn detection messages received from an elder customer terminal and the storage of the smart phone ID information of a guardian or a manager corresponding to a terminal ID, in response to a request from a manager.

The SMS gateway 108 and the communication company system 110 send an SMS message to any one of the first to M-th smart phones 1121 to 112M in response to a request from the controller 102.

Any one of the first to M-th smart phones 1121 to 112M receives the SMS message, provides guidance, and indicates the position of an elder customer terminal that sent the fall or overturn detection message on a map based on latitude and longitude information included in the SMS message in response to a request from the customer.

### <Configuration of Elder Customer Terminal>

The configuration of the elder customer terminal according to an exemplary embodiment of the present invention will now be described with reference to FIG. 2. Here, the first to N-th elder customer terminals 1001 to 100M have the same operation and configuration, and thus the operation and configuration of only one elder customer terminal will be described in detail.

The elder customer terminal includes a control module 200, a memory unit 202, a button unit 204, a Light Emitting Diode (LED) alarm lamp 206, a speaker 208, a 3-axis acceleration sensor 210, a Radio Frequency (RF) transmission/reception module 212, and a Global Positioning System (GPS) module 214.

The control module 200 generally controls the elder customer terminal. Furthermore, according to a preferred embodiment of the present invention, the control module 200 detects a fall or overturn accident based on a value detected by the 3-axis acceleration sensor 310, and, when the fall or overturn accident is detected, generates a fall or overturn detection message and notifies the controller 102 of the fall or overturn accident via the RF transmission/reception module 212.

Furthermore, when an alarm lamp drive command is received from the controller 102, the control module 200 drives the LED alarm lamp 206. When a confirm button included in the button unit 204 is pressed, the control module 200 notifies the controller 102 of information corresponding to the pressed confirm button.

Furthermore, when an alarm output and alarm lamp drive command are received from the controller 102, the control module 200 outputs an alarm via the speaker 208 and, at the same time, drives the LED alarm lamp 206.

The memory unit 202 stores various pieces of information including the control program of the control module 200 and, in particular, stores a terminal ID (i.e., ID information about the elder customer terminal).

The button unit 204 includes a plurality of buttons including a confirm button, and provides the control module 200 with information corresponding to a pressed button.

The LED alarm lamp 206 is driven under the control of the control module 200.

The 3-axis acceleration sensor 210 senses 3-axis acceleration, and provides the control module 200 with a detection value corresponding to the detection.

The RF transmission/reception module 212 is responsible for wireless communication between the controller 102 and the control module 200 using a frequency band of 400 MHz.

The GPS module 214 receives GPS information, calculates a current position based on the GPS satellite information, and provides information about the current position to the control module 200. Here, the current position information is latitude and longitude information.

<Method of Automatically Transferring Information about a Fall or Overturn Accident Using a Smart Phone>

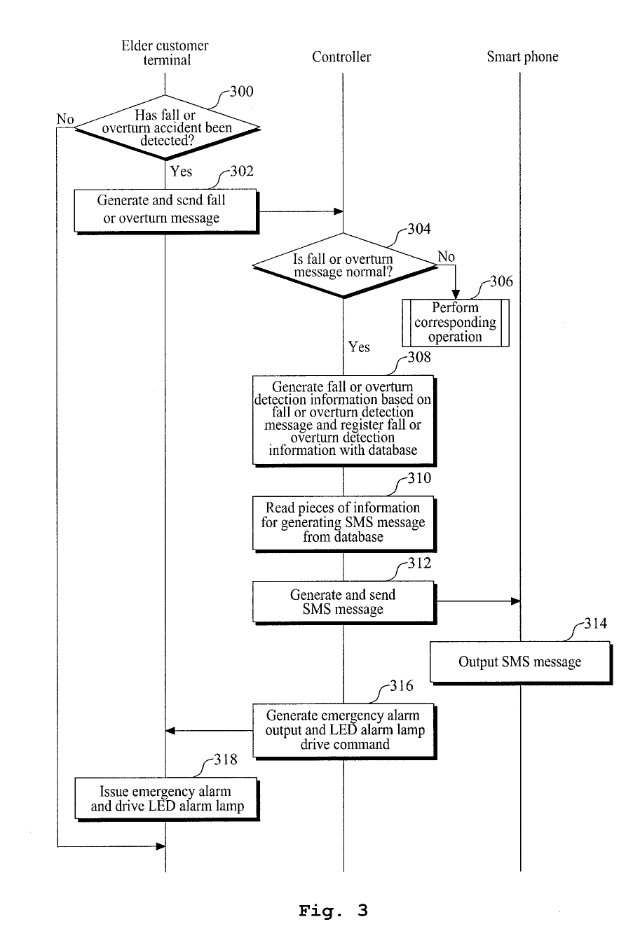

A method of automatically transferring information about a fall or overturn accident using a smart phone according to an exemplary embodiment of the present invention will now be described in detail with reference to the flowchart of FIG. 3.

When a fall or overturn accident is detected at step 300, any one of the first to N-th elder customer terminals 1001 to 100M generates a fall or overturn message and sends the fall or overturn message to the controller 102 at step 302.

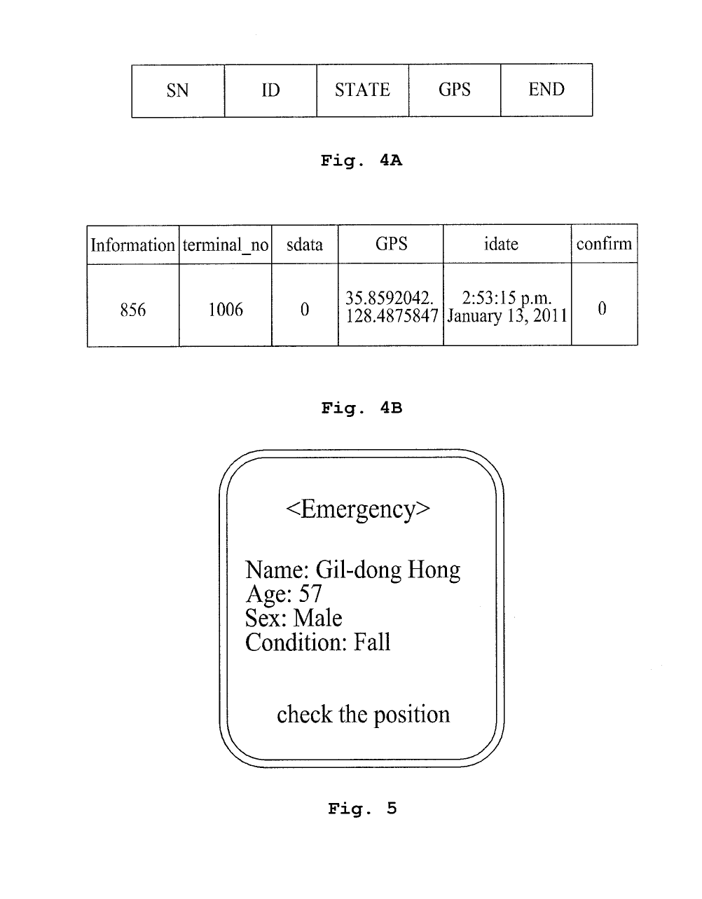

Referring to FIG. 4A, the fall or overturn detection message includes SN, ID, STATE, GPS, and END. Here, ‘SN’ is Char-type 2 bytes, and is always F0. ‘F0’ is used to confirm that the fall or overturn detection message is a message from an elder customer terminal ‘ID’ is Char-type 4 bytes, and an elder customer terminal ID is assigned a number in the range from 0000 to 2555. ‘0000’ is assigned to the controller 102. STATE is a Char-type 1 byte, and indicates the state of the elder customer terminal. That is, ‘STATE’ has P, F, T, S, and R values. Here, ‘P,’ ‘F,’ ‘T,’ ‘5,’ and ‘R’ indicate power-on, a fall, a stop state, a call, and power off, respectively. Furthermore, ‘END’ indicates the end of data, which is represented by ‘EE’. Furthermore, ‘GPS’ is information about a current position (i.e., latitude and longitude information).

For example, when the message ‘F01002F**EE’ is sent, a fall accident has occurred to an elder customer terminal No. 1002 and the position of the elder customer terminal and the position of the accident is ** because ‘F0’ indicates the start of message data, ‘1002’ indicates that the elder customer terminal ID is 1002, ‘F’ indicates a fall, ‘**’ indicates the position, and ‘EE’ indicates the end of the message data.

When the fall or overturn detection message is received, the controller 102 executes the event ‘void serialPort_DataReceived(object sender, SerialDataReceivedEventArgse)’, changes the fall or overturn detection message to a byte arrangement, converts the byte arrangement into a character string, and checks whether the character string complies with a preset format at step 304.

If the fall or overturn detection message complies with the preset format, the controller 102 generates fall or overturn detection information based on the fall or overturn detection message, and also registers the generated fall or overturn detection information with the database 104 at step 308.

A method for analyzing and checking the fall or overturn detection message is described as follows:

1. public void serialdata_insert(string data)
Here, ‘data’ is a message sent by the elder customer terminal, and is

‘F01002F**EE’.

2. id = data.Substring(ch + 2, 4);
The terminal id ‘1002’ is found by reading four characters from

the third character of the data.

3. sd = data.Substring(ch + 6, 1);
The terminal state ‘F’ is found by reading one character from the

seventh character of the data.

If a plurality of fall or overturn detection messages is received, the above process is repeated to analyze and check the plurality of fall or overturn detection messages.

After the fall or overturn detection message is analyzed and checked, the controller 102 generates the fall or overturn detection information, including part of the fall or overturn detection message and reception time information, and registers the generated fall or overturn detection information with the database 104. A method for generating the fall or overturn detection information is described as follows:

4. query = “insert into sdata(terminal_id, sdata, gps, idate)values
(‘“ + id + ’”, ‘“ + sd + ’”, ‘“ + gps + ’”, now( ))”
5. Comm = new OleDbCommand(query, conn);
6. Comm.ExecuteNonQuery( );

In “4.,” ‘ID’ and ‘SD’ are values obtained by converting the elder customer terminal ID and an elder customer terminal state into integers, ‘gps’ is information about the position of the elder customer terminal, and ‘now( )’ is the time at which the message was received.

FIG. 4B shows the fall or overturn detection information registered with the database 104. In FIGS. 4A and 4B, ‘Information’ is an input data order, ‘terminal no’ is a terminal ID, ‘sdata’ is a state, ‘GPS’ is position information, and ‘idata’ is the date and hour when the data was input. ‘confirm’ indicates whether an SMS message has been sent, ‘0’ indicates that the SMS message has not been sent, and ‘1’ indicates that the SMS message has been sent.

After the fall or overturn detection information is registered with the database 104 as described above, the controller 102 reads pieces of information for automatically transferring the fall or overturn accident from the database 104 at step 310. A method for reading the pieces of information is described as follows:

7. query = “select name, age, sex, latitude, longitude, telephone from

member m, equip e where m.id = e.m_id and e.code = ‘“ + id+’””

8. Comm = new OleDbCommand(query, conn);
9. rs = Comm.ExecuteReader( );

In the method, the name, age, sex, latitude, longitude, and telephone number of an elder customer who was found using the elder customer terminal id of “7.” as a key are retrieved. The telephone number is the mobile phone number of a caregiver (or a nurse in charge). Furthermore, the controller 102 accesses the database 104 based on “8.” and reads the pieces of information from the database 104 based on rs of “9.” ‘rs’ is an object declared in OleDbDataReader form. The object functions to store data read from the database 104.

After reading the pieces of information for automatically transferring information about the fall or overturn accident from the database 104 as described above, the controller 102 generates the SMS message. A method for generating the SMS message is described as follows:

10. sms_msg =
rs[“name”].ToString( )+”|”+rs[“age”].ToString( )+”|”+rs

[“sex”].ToString( )+”|”+sdata+”|”+rs[“latitude”]+”|”+rs[“longitude”];

11. sms1 = rs[“telephone”];
12. webBrowser1.Navigate(“http://www.singnjoy.com/contents
/sms.html?mode=sms&hphone=“+sms1+”&msg=“+sms_msg);

In the method, “10.” is a sentence for generating the SMS message using the pieces of information (i.e., the name, age, sex, latitude, and longitude of the elder customer) read from the database 104. Furthermore, ‘sdata’ is the elder customer terminal state converted into an integer. In the method, the controller 102 receives the telephone number to which text will be sent using “11. sms1,” accesses the SMS gateway 108 using the address (i.e., http://www.singnjoy.com/) of the SMS gateway 108 of “12.,” and sends the SMS message.

The content of the generated SMS message is ‘name|age|sex|terminal state|latitude|longitude’. The controller 102 accesses the SMS gateway 108 having the address (i.e., http://www.singnjoy.com/) using the telephone number sms1 and sends the generated SMS message at step 312.

If ‘latitude|longitude’ is, for example, ‘35.8592042|128.4875847,’ the controller 102 displays ‘35.8592042|128.4875847’ on a map via the manager terminal 106, and indicates an accident position. Furthermore, the controller 102 provides an emergency alarm output and LED alarm lamp drive command to the elder customer terminal that sent the fall or overturn detection message at step 316. The elder customer terminal issues an emergency alarm in response to the emergency alarm output and LED alarm lamp drive command and, at the same time, drives the LED alarm lamp 206 at step 318.

Furthermore, a smart phone that has received the SMS message parses and displays the SMS message at step 314. The SMS message is received in the form of ‘Hong Gil-dong|54|Male|F|35.8592042|128.4875847.’ The smart phone parses the character string of the SMS message based on the discriminator “1,” and stores information for each parameter. That is, name=Hong Gil-dong, age=54, sex=Male, sdata=F, latitude=35.8592042, and longitude=128.4875847. The process is processed by on Receiver( ) that is performed at the same time that the SMS message is received.

public class smsReceiver extands BroadcastReceiver{
public void onReceiver( ){

.
.

}
A task performed by onReceiver( ) is described as follows:
if (text received == true) {
character string parsing;
Name, age, sex, terminal state, latitude, and longitude are stored in

respective parameters;

13. Perform Toast( ) function;
if (‘position confirm’ button click == true) {
14. Perform onCreate( ) function;

}

}

Referring to FIG. 5, when “13. Toast( ) function” is performed, a toast message is output via the screen of the smart phone.

A caregiver, a nurse in charge, or a guardian who has received the toast message may touch an area “check the position” shown in FIG. 5. In this case, the smart phone performs the on Create( ) function of “14.” and displays the position and state on a map. Here, the smart phone sends the name, the age, the sex, and the elder customer terminal state, together with latitude and longitude, as parameters, and displays them on the map.

The on Create( )method displayed on the map is subjected to the following process:

public class map extends MapActivity {
public void onCreate( ){
Generate view;
new GeoPoint(latitude, longitude); // pass latitude and longitude

to the map

15. Execute map class;
Display a relevant position on the map;
Enlarge the map;

}

}

The map class of “15.” displays a position, corresponding to the latitude and longitude, on the screen while operating in conjunction with Google Maps.

In the preferred embodiment of the present invention, only an example in which the controller 102 outputs an emergency alarm to the elder customer terminal and, at the same time, issues a command to drive the LED alarm lamp 206, has been illustrated.

In an alternative embodiment, when the elder customer terminal detects a fall or overturn, the elder customer terminal may output an emergency alarm without control of the controller 102 and, at the same time, drive the LED alarm lamp 206. This embodiment is apparent from the present invention.

Furthermore, in the embodiment of the present invention, an example in which the elder customer terminal including the GPS module 214 provides its own current position has been illustrated. If a method of estimating a position using the intensity of a received radio signal is used, however, a relay may estimate the position of the elder customer terminal even when the GPS module 214 is not included in the elder customer terminal.

As described above, according to the present invention, the safety of a plurality of elder customers may be guaranteed by monitoring the fall or overturn accidents of the plurality of elder customers, and the burden of costs attributable to the distribution of terminals and communication may be significantly reduced by simplifying the configuration of the terminal and using 400 MHz band wireless communication.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of automatically transferring information about a fall or overturn accident using a smart phone, the method comprising:
by an elder customer terminal assigned to an elder customer, detecting a fall or overturn accident via a 3-axis acceleration sensor, and sending a fall or overturn detection message, including its own ID information and a fall or overturn state, to a controller based on the detection;
by the controller, receiving the fall or overturn detection message, generating fall or overturn detection information based on the received fall or overturn detection message, and registering the fall or overturn detection information with a database; and
by the controller, configuring a message based on the fall or overturn detection information, and notifying the smart phone of the message based on the fall or overturn detection information.

2. The method as set forth in claim 1, wherein:
the elder customer terminal outputs an emergency alarm or drives an LED alarm lamp when the fall or overturn accident is detected; or
the elder customer terminal outputs the emergency alarm or drives the LED alarm lamp in compliance with a command from the controller.

3. The method as set forth in claim 1, wherein:
the elder customer terminal comprises a GPS module;
the elder customer terminal adds position information, received from the GPS module, to the fall or overturn detection message, and then sends the fall or overturn detection message to the controller; and
the controller adds the position information to the fall or overturn detection information and to the message based on the fall or overturn detection information, and then provides the message to the smart phone.

4. The method as set forth in claim 3, wherein:
the smart phone, when receiving the message including the position information, displays the position information on a map and displays part of the message based on the fall or overturn detection information; and
the fall or overturn detection information comprises a name, sex, and age of an elder customer corresponding to the elder customer terminal.

5. The method as set forth in claim 1, wherein:
the message based on the fall or overturn detection information is an SMS message, an MMS message, or a push notification message;
preset discriminators are inserted among items of the message; and
the smart phone parses character strings of the items of the message using the discriminators.

6. A system for automatically transferring information about a fall or overturn accident using a smart phone, the system comprising:
an elder customer terminal assigned to an elder customer, and configured to sense the fall or overturn accident via a 3-axis acceleration sensor and to send a fall or overturn detection message, including its own ID information and fall or overturn state, based on the detection; and
a controller configured to receive the fall or overturn detection message, to generate fall or overturn detection information based on the received fall or overturn detection message, to register the fall or overturn detection information with a database, to configure a message based on the fall or overturn detection information, and to notify the smart phone of the message based on the fall or overturn detection information.

7. The system as set forth in claim 6, wherein the elder customer terminal outputs an emergency alarm or drives an LED alarm lamp when the fall or overturn accident is detected, or the elder customer terminal outputs the emergency alarm or drives the LED alarm lamp in compliance with a command from the controller.

8. The system as set forth in claim 6, wherein:
the elder customer terminal comprises a GPS module;
the elder customer terminal adds position information, received from the GPS module, to the fall or overturn detection message, and then sends the fall or overturn detection message to the controller; and
the controller adds the position information to the fall or overturn detection information and to the message based on the fall or overturn detection information, and then provides the message to the smart phone.

9. The system as set forth in claim 8, wherein:
the smart phone, when receiving the message including the position information, displays the position information on a map and displays part of the message based on the fall or overturn detection information; and
the fall or overturn detection information comprise a name, sex, and age of an elder customer corresponding to the elder customer terminal.

10. The system as set forth in claim 6, wherein:
the message based on the fall or overturn detection information is an SMS message, an MMS message, or a push notification message;
preset discriminators are inserted among items of the message; and
the smart phone parses character strings of the items of the message using the discriminators.
